(19) United States
(12) Patent Application Publication
(10) Pub. No.: US 2014/0327241 A1
(43) Pub. Date: Nov. 6, 2014

(54) Ion Transport Membrane Assembly with Multi-Layer Seal

(71) Applicant: AIR PRODUCTS AND CHEMICALS, INC., Allentown, PA (US)

(72) Inventors: Stephen Clyde Tentarelli, Schnecksville, PA (US); Andrew Wilson Wang, Macungie, PA (US); Lori Lucille Anderson, Allentown, PA (US); Eric Minford, Laurys Station, PA (US); Richard Paul Underwood, Allentown, PA (US)

(73) Assignee: AIR PRODUCTS AND CHEMICALS, INC., Allentown, PA (US)

(21) Appl. No.: 14/296,918

(22) Filed: Jun. 5, 2014

(51) Int. Cl. F16L 25/00

(52) U.S. Cl. CPC F16L 25/0018
USPC 285/335

(57) ABSTRACT

An ion transport membrane assembly comprising a pressure vessel, a plurality of planar ion transport membrane modules having ceramic conduits, one or more gas manifolds having metal conduits, and multi-layer seals connecting the ceramic conduits to the metal conduits. The multi-layer seals comprise two or more compliant gasket layers and one or more shear gasket layers.

### STATEMENT REGARDING FEDERALLY SPONSORED RESEARCH OR DEVELOPMENT

This invention was made at least in part with funding from the United States Department of Energy under DOE Cooperative Agreement No. DE-FC26-98FT40343. The United States Government has certain rights in this invention.

### BACKGROUND

Ion transport membrane devices require metal conduit to ceramic conduit transitions. Typically, the ceramic ion transport membrane device will need to be coupled to a metallic piping system to convey the permeate side product to the next process operation. It is neither economically nor mechanically practical to use the same ceramic material for this piping system as is used in the membranes. The transition from metal to ceramic must remain sufficiently leak-free in spite of substantial changes in operating temperature, pressure, and gas composition. Thus, a seal between the metal conduit and the ceramic conduit is required that will accommodate the large differences in coefficients of thermal expansion and chemical expansion, and also provide robust performance over long periods of operation at temperatures in excess of 800° C. and pressures of up to about 2.5 MPa (absolute) (350 psig), the pressure difference providing a compressive force on the seal. The seal must be able to provide sealing at both high pressure and low pressure. It is also necessary that the seal components in contact with the metal and ceramic parts be chemically compatible with these parts.

While particularly suited for ion transport membrane devices, the multi-layer seal between a ceramic part and a metal part described herein may find applicability to other technologies that operate at similar temperatures and pressures and require sufficiently leak-free sealing.

Industry desires a seal between ceramic conduits and metal conduits that are sufficiently leak-tight and durable.

### BRIEF SUMMARY

The present invention relates to an ion transport membrane assembly comprising a multi-layer seal connecting a ceramic conduit to a metal conduit.

There are several aspects of the seal as outlined below. In the following, specific aspects of the ion transport membrane assembly will be outlined. The reference numbers and expressions set in parentheses are referring to an example embodiment explained further below with reference to the figures. The reference numbers and expressions are, however, only illustrative and do not limit the aspect to any specific component or feature of the example embodiment. The aspects can be formulated as claims in which the reference numbers and expressions set in parentheses are omitted or replaced by others as appropriate.

Aspect 1. An ion transport membrane assembly (1) comprising:
(a) a pressure vessel (10) having an interior (12), an exterior (14), an inlet (16), a first outlet (18) and a second outlet (8);
(b) a plurality of planar ion transport membrane modules (21-25) operatively disposed in the interior (12) of the pressure vessel (10), each planar ion transport membrane module (21-25) comprising mixed metal oxide ceramic material and having an interior region and an exterior region, each membrane module (21-25) terminating in a ceramic conduit (31-35) having a sealing surface (65), wherein the inlet (16) and the first outlet (18) of the pressure vessel (10) are in fluid flow communication with the exterior regions of the membrane modules (21-25);
(c) one or more gas manifolds (41-45) in fluid flow communication with interior regions of the membrane modules (21-25) and with the exterior (14) of the pressure vessel (10),
wherein the ceramic conduit (31-35) of each membrane module (21-25) is connected to a metal conduit (51-55) of the one or more gas manifolds (41-45) with a multi-layer seal operatively disposed therebetween, each metal conduit (51-55) having a sealing surface (85);
wherein each multi-layer seal comprises:
   a first shear gasket layer (71);
   a first compliant gasket layer (61) wherein the first compliant gasket layer directly contacts the sealing surface (65) of the ceramic conduit; and
   a second compliant gasket layer (81) wherein the second compliant gasket layer (81) directly contacts the sealing surface (85) of the metal conduit (51);
   wherein the first shear gasket layer (71) is operatively disposed between the first compliant gasket layer (61) and the second compliant gasket layer (81).

Aspect 2. The ion transport membrane assembly of aspect 1 wherein the multi-layer seal further comprises:
a second shear gasket layer (91); and
third compliant gasket layer (101);
wherein the third compliant gasket layer (101) is operatively disposed between the first shear gasket layer (71) and the second shear gasket layer (91); and
wherein the second shear gasket layer (91) is operatively disposed between the third compliant gasket layer (101) and the second compliant gasket layer (81).

Aspect 3. The ion transport membrane assembly of aspect 1 or aspect 2 wherein the first shear gasket layer (71) and/or the second shear gasket (91) comprises a mineral selected from the group consisting of mica, vermiculite, montmorillonite, graphite, and hexagonal boron nitride.

Aspect 4. The ion transport membrane assembly of any one of the preceding aspects wherein at least one of the first compliant gasket layer (61), the second compliant gasket layer (81) and the third compliant gasket layer (101) comprises a material selected from the group consisting of a glass, a glass-ceramic, a glass composite, a cermet, a metal, a metal alloy, and a metal composite.

Aspect 5. The ion transport membrane assembly of any one of the preceding aspects wherein the first shear gasket layer and/or the second shear gasket layer comprises at least 95 weight % of a mineral selected from the group consisting of mica, vermiculite, montmorillonite, graphite, and hexagonal boron nitride.

Aspect 6. The ion transport membrane assembly of any one of the preceding aspects wherein the first compliant gasket layer and the second compliant gasket layer is a metal comprising at least 95 weight % of gold, silver, palladium, or alloys thereof.

Aspect 7. The ion transport membrane assembly of any one of the preceding aspects wherein the material of the third compliant gasket layer (101) is a glass, a glass-ceramic or a glass composite.

Aspect 8. The ion transport membrane assembly of any one of the preceding aspects wherein the first shear gasket layer has a thickness ranging from 0.025 mm to 0.75 mm, or ranging from 0.025 mm to 0.25 mm, and the second shear gasket layer has a thickness ranging from 0.025 mm to 0.75 mm, or ranging from 0.025 mm to 0.25 mm.

Aspect 9. The ion transport membrane assembly of any one of the preceding aspects wherein the first compliant gasket layer has a thickness ranging from 0.0025 mm to 1.25 mm, or ranging from 0.025 mm to 1.25 mm, prior to heating and the second compliant gasket layer has a thickness ranging from 0.0025 mm to 1.25 mm, or ranging from 0.025 to 1.25 mm prior to heating.

Aspect 10. The ion transport membrane assembly of any one of the preceding aspects wherein the third compliant gasket layer has a thickness ranging from 0.025 mm to 2.5 mm or ranging from 0.025 to 1.25 mm prior to heating.

Aspect 11. The ion transport membrane assembly of any one of the preceding aspects wherein the thickness of the third compliant gasket layer is greater than the thickness of the first compliant gasket layer and greater than the thickness of the second compliant gasket layer.

Aspect 12. The ion transport membrane assembly of any one of the preceding aspects wherein at least one of the first shear layer and the second shear layer possesses the characteristic of lubricity or is a sheet-like structure comprising sheets or flakes which can be displaced relative to one another in directions which are essentially parallel to the sheets or flakes.

Aspect 13. The ion transport membrane assembly of any one of the preceding aspects wherein the ceramic conduit (31-35) of each membrane module is constructed of one or more single phase multicomponent metal oxides and/or of one or more multiphase composite materials.

Aspect 14. The ion transport membrane assembly of any one of the preceding aspects wherein the ceramic conduit of each membrane module has a circular cross-section.

Aspect 15. The ion transport membrane assembly of any one of the preceding aspects wherein each of the metal conduits of the one or more gas manifolds has a circular cross-section.

Aspect 16. The ion transport membrane assembly of any one of the preceding aspects wherein each of the first compliant gasket layer, the second compliant gasket layer, the third compliant gasket layer, the first shear gasket layer, and the second shear gasket layer have a circular cross-section.

### BRIEF DESCRIPTION OF SEVERAL VIEWS OF THE DRAWINGS

FIG. 1A is a schematic side view of the interior of an ion transport membrane assembly with a 3 layer seal.

FIG. 1B is a cross sectional view of FIG. 1A.

FIG. 2A is a schematic side view of the interior of an ion transport membrane assembly with a 5 layer seal

FIG. 2B is a cross sectional view of FIG. 2A.

### DETAILED DESCRIPTION OF THE PREFERRED EMBODIMENTS

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity. The term “and/or” placed between a first entity and a second entity means one of (1) the first entity, (2) the second entity, and (3) the first entity and the second entity. The term “and/or” placed between the last two entities of a list of 3 or more entities means at least one of the entities in the list including any specific combination of entities in this list.

As used herein, “first,” “second,” “third,” etc. are used to distinguish from among a plurality of steps and/or components and/or features, and is not indicative of the relative position in time and/or space.

Where a weight % value is presented, this value is the fraction of the total weight of the respective component e.g. a shear gasket layer or a compliant gasket layer.

The following definitions apply to terms used in the description of the embodiments of the invention presented herein.

An “ion transport membrane assembly” is a generic term for an array of multiple ion transport membrane modules and associated hardware used for oxygen recovery or for oxidation reactions. An ion transport membrane assembly may be an ion transport membrane separation assembly, which is an ion transport membrane system used for separating and recovering oxygen from an oxygen-containing gas. An ion transport membrane assembly may be an ion transport membrane reactor system, which is an ion transport membrane system used for oxidation reactions.

An “ion transport membrane assembly,” also called an “ion transport membrane system,” comprises a plurality of membrane modules, a pressure vessel containing the one or more membrane modules, and any additional components necessary to introduce one or more feed streams and to withdraw two or more effluent streams formed from the one or more feed streams. The additional components may comprise flow containment duct(s), insulation, manifolds, etc. as is known in the art. The plurality of membrane modules may be arranged in parallel and/or in series.

An “ion transport membrane module,” sometimes called a “membrane stack,” is an array of a plurality of membrane units.

A “membrane unit,” also called a “membrane structure,” has a gas inflow region and a gas outflow region operatively disposed such that gas flows across the surfaces of the membrane units. Gas flowing from the inflow region to the outflow region of a membrane module changes in composition as it passes across the surfaces of the membrane structures in the module. Each membrane unit has an oxygen-containing gas feed side and a permeate side separated by an active membrane layer or region that allows oxygen ions to permeate therethrough. Each membrane unit also has an interior region and an exterior region.

In one embodiment, in which the membrane module is operated as an oxygen separation device, the oxygen-containing gas feed side may be adjacent to the exterior region of the membrane structure and the permeate side may be adjacent to the interior region of the membrane structure.

In another embodiment, in which the membrane module is operated as an oxidation reaction device, the oxygen-containing gas feed side may be adjacent to the interior region of the membrane structure and the permeate side may be adjacent to the exterior region of the membrane structure. In this alternative embodiment, a reactant feed gas flows through the exterior region of the membrane structure and reacts with the permeated oxygen. Thus in this embodiment the permeate side is also the reactant gas side of the membrane structure. A catalyst may be provided on the reactant gas side of the membrane structure.

The membrane unit may have a planar configuration in which a wafer having a center or interior region and an exterior region is formed by two parallel planar members sealed about at least a portion of the peripheral edges thereof. Oxygen ions permeate through active membrane material that may be placed on either or both surfaces of a planar member. Gas can flow through the center or interior region of the wafer, and the wafer has one or more gas flow openings to allow gas to enter and/or exit the interior region of the wafer. Thus oxygen ions may permeate from the exterior region into the interior region, or conversely may permeate from the interior region to the exterior region.

Membrane units may have any configuration known in the art. When a membrane unit has a planar configuration, it is typically called a “wafer.”

Components of a membrane unit include an ion transport membrane, which is an active layer of ceramic membrane material comprising mixed metal oxides capable of transporting or permeating oxygen ions at elevated temperatures. The ion transport membrane also may transport electrons as well as oxygen ions, and this type of ion transport membrane typically is described as a mixed conductor membrane. The membrane unit may also include structural components that support the active membrane layer, and structural components to direct gas flow to and from the membrane surfaces. The structural components may include porous support layers, slotted support layers, and flow channel layers as are known in the art. The active membrane layer typically comprises mixed metal oxide ceramic material and also may comprise one or more elemental metals thereby forming a composite membrane. The structural components of the membrane module may be made of any appropriate material such as, for example, mixed metal oxide ceramic materials, and also may comprise one or more elemental metals. Any of the active membrane layer and structural components may be made of the same material.

Single modules may be arranged in series, which means that a number of modules are disposed along a single axis. Typically, gas which has passed across the surfaces of the membrane structures in a first module flows from the outflow region of that module, after which some or all of this gas enters the inflow region of a second module and thereafter flows across the surfaces of the membrane structures in the second module. The axis of a series of single modules may be parallel or nearly parallel to the overall flow direction or axis of the gas passing over the modules in series.

Modules may be arranged in banks of two or more parallel modules wherein a bank of parallel modules lies on an axis that is not parallel to, and may be generally orthogonal to, the overall flow direction or axis of the gas passing over the modules. Multiple banks of modules may be arranged in series, which means by definition that banks of modules are disposed such that at least a portion of gas which has passed across the surfaces of the membrane structures in a first bank of modules flows across the surfaces of the membrane structures in a second bank of modules.

Any number of single modules or banks of modules may be arranged in series. In one embodiment, the modules in a series of single modules or in a series of banks of modules may lie on a common axis or common axes in which the number of axes equals one or equals the number of modules in each bank. In another embodiment described below, successive modules or banks of modules in a series of modules or banks of modules may be offset in an alternating fashion such that the modules lie on at least two axes or on a number of axes greater than the number of modules in a bank, respectively. Both of these embodiments are included in the definition of modules in series as used herein.

Preferably, the gas in contact with the outer surfaces in the exterior regions of the membrane modules is at a higher pressure than the gas within the interior regions of the membrane modules.

A flow containment duct is defined as a conduit or closed channel surrounding a plurality of series membrane modules which directs flowing gas over modules in series.

A manifold is an assembly of pipes or conduits which directs gas to enter and/or exit the interior regions of the membrane modules. Two manifolds may be combined by installing a first or inner conduit within a second or outer conduit wherein the first conduit provides a first manifold and the annulus between the conduits provides a second manifold. The conduits may be concentric or coaxial, wherein these two terms have the same meaning. Alternatively, the conduits may not be concentric or coaxial but may have separate parallel or nonparallel axes. This configuration of inner and outer conduits to provide a combined manifold function is defined herein as a nested manifold.

Fluid flow communication means that components of membrane modules and vessel systems are oriented relative to one another such that gas can flow readily from one component to another component.

A wafer is a membrane structure having a center or interior region and an exterior region wherein the wafer is formed by two parallel planar members sealed about at least a portion of the peripheral edges thereof. Active membrane material may be placed on either or both surfaces of a planar member. Gas can flow through the center or interior region of the wafer, i.e., all parts of the interior region are in flow communication, and the wafer has one or more gas flow openings to allow gas to enter and/or exit the interior region of the wafer. The interior region of the wafer may include porous and/or channeled material that allows gas flow through the interior region and mechanically supports the parallel planar members. The active membrane material transports or permeates oxygen ions but is impervious to the flow of any gas.

Exemplary ion transport membrane layers, membrane units, membrane modules, and ion transport membrane assemblies (systems) are described in U.S. Pat. Nos. 5,681,373 and 7,179,323.

The present invention relates to an ion transport membrane assembly. The ion transport membrane assembly is described with reference to the figures.

The ion transport membrane assembly comprises a pressure vessel 10 having an interior 12, an exterior 14, an inlet 16, a first outlet 18 and a second outlet 8.

The ion transport membrane assembly also comprises a plurality of planar ion transport membrane modules 21, 22, 23, 24, 25 disposed in the interior 12 of the pressure vessel 10. Each planar ion transport membrane module 21-25 comprises mixed metal oxide ceramic material and having an interior region and an exterior region. Each membrane module 21-25 terminates in a ceramic conduit 31, 32, 33, 34, 35, respectively, having a sealing surface 65. The inlet 16 and the first outlet 18 of the pressure vessel 10 are in fluid flow communication with the exterior regions of the membrane modules 21-25.

The ceramic conduits 31-35 may be constructed of any ceramic known for use in ion transport membrane devices, for example, single phase multicomponent metal oxides or multiphase composite materials. Examples of single phase multicomponent metal oxides include mixed oxygen ion and electron conducting perovskites and doped lanthanum nicklates. Examples of multiphase composite materials include two phase mixtures of an ionic conductor such as a fluorite with an electronic conductor such as a perovskite. Examples of mixed oxygen ion and electron conducting perovskites include compositions in the LnₓA′_{x′}A″_{x″}B_{y}B′_{y′}B″_{y′}O_{3-z} where Ln is selected from La and the lanthanide elements; A′ is selected from the alkaline earth elements, and A″ is independently selected from La, the lanthanide elements and the alkaline earth elements; B, B′ and B″ are independently selected from the first row transition metals, Al, Ga and Mg; 0≦x≦1; 0≦x′≦1; 0≦x″≦1; 0<y≦1; 0≦y′≦1; 0≦y″≦1; x+x′+x″=1; 0.9<y+y′+y″<1, 1; and z is a number to make the compound charge neutral.

The ion transport membrane assembly also comprises one or more gas manifolds 41, 42, 43, 44, 45 in fluid flow communication with interior regions of the membrane modules 21-25 and with the exterior 14 of the pressure vessel 10.

The ceramic conduit 31-35 of each membrane module 21-25 is connected to a respective metal conduit 51, 52, 53, 54, 55 of the one or more gas manifolds 41-45 with a multi-layer seal disposed therebetween. Each metal conduit 51-55 has a sealing surface 85.

The metal conduits 51-55 may be constructed of any metal known for use in ion transport membrane devices. Suitable metals may include, for example, Incoloy® 800H, Incoloy® 800, Incoloy® 800HT, 253MA, 353MA, Haynes® 230, Haynes® 214, Haynes® HR-120, Inconel® 600, Inconel® 601, and Inconel® 602 CA.

Each multi-layer seal comprises a first shear gasket layer 71, a first compliant gasket layer 61, and a second compliant gasket layer 81. The first compliant gasket layer 61 of each multi-layer seal directly contacts the sealing surface 65 of the respective ceramic conduit 31-35. The second compliant gasket layer 81 of each multi-layer seal directly contacts the sealing surface 85 of the respective metal conduit 51-55. The first shear gasket layer 71 of each multi-layer seal is operatively disposed between the first compliant gasket layer 61 and the second compliant gasket layer 81.

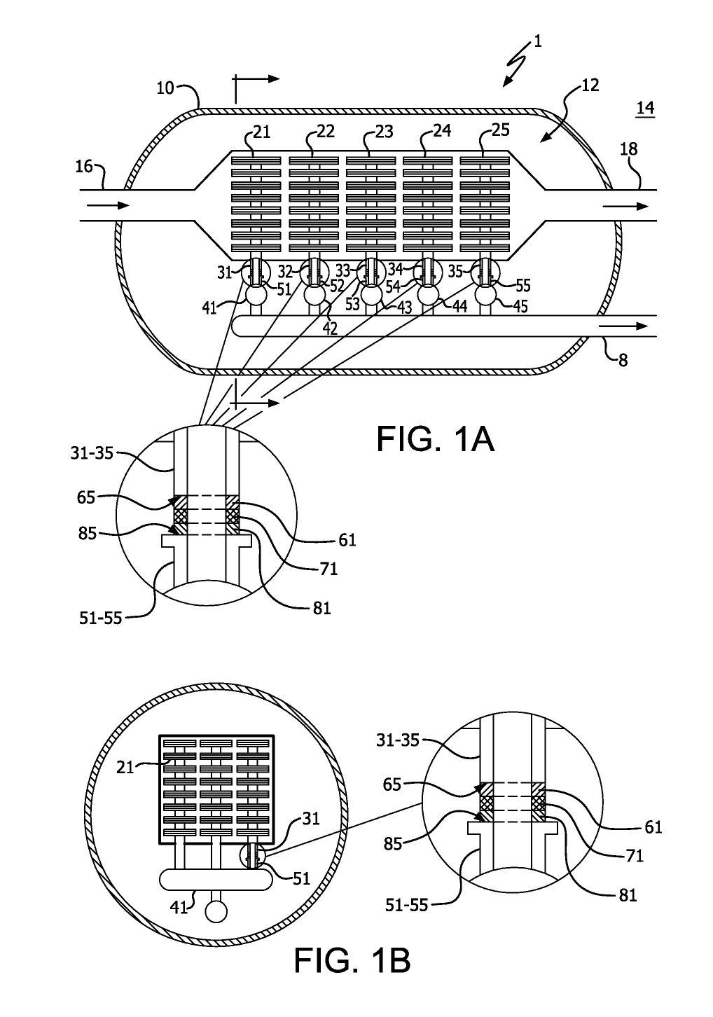

FIG. 1A and FIG. 1B illustrate a 3 layer seal with the first shear gasket layer 71, the first compliant gasket layer 61, and the second compliant gasket layer 81.

Each multi-layer seal may further comprise a second shear gasket layer 91 and third compliant gasket layer 101. The third compliant gasket layer 101, if present, is operatively disposed between the first shear gasket layer 71 and the second shear gasket layer 91. The second shear gasket layer 91, if present, is operatively disposed between the third compliant gasket layer 101 and the second compliant gasket layer 81.

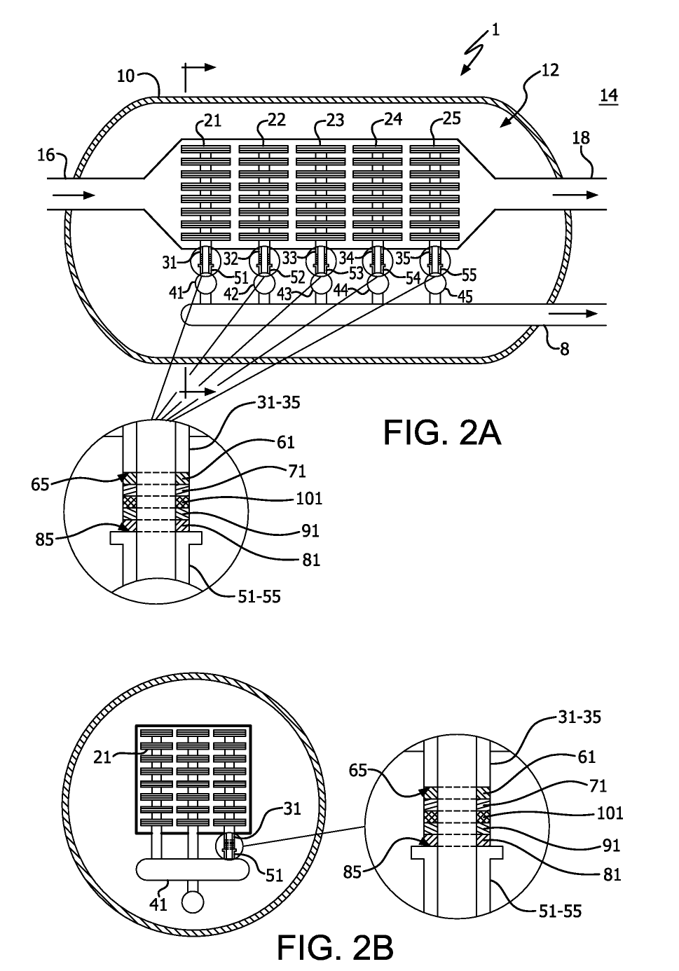

FIG. 2A and FIG. 2B illustrate a 5 layer seal with the first shear gasket layer 71, the first compliant gasket layer 61, the second compliant gasket layer 81, the second shear gasket layer 91, and the third compliant gasket layer 101.

The multi-layer seals prevent flow of a fluid through the junction from outside of the conduits to the inside of the joined conduits, or from the inside of the conduits to the outside of the joined conduits. The sealing surface of the ceramic conduit and the sealing surface of the metal conduit may be at least essentially parallel to each other and/or separated by a distance equal to the thickness of the compressed multi-layer gasket.

The first shear gasket layer 71 and the second shear gasket layer 91, if present, possess the ability to accommodate shear strain acting parallel to the plane of the seal surface (parallel to the sealing surfaces of the metal and ceramic conduits). Thus, the material of the shear gasket layers, either must have a low coefficient of friction when placed in contact with either the ceramic body or the compliant layer, or they must possess a structure that allows it to undergo shear strain at low stress.

The first shear gasket layer 71 and the second shear gasket layer 91, if present, are “shear layers” or “slip layers” that possesses the characteristic of lubricity or is a sheet-like structure in which the sheets can be displaced across (parallel to) one another. In this way, the shear layer accommodates the differences in thermal and chemical expansion of the metal and ceramic conduits.

As used herein, the term “compliant” is intended to refer to a property of the material whereby, under operating conditions of the ion transport membrane device, the material has a degree of plastic deformation under a given compressive force so that it conforms to adjacent surfaces to block gas leakage pathways through the junction. Such gas leakage pathways can result, for example, from defects in the adjacent surfaces of the components, or other irregularities in the surfaces including grooves on a metal component or grooves or voids on a ceramic component.

A compliant gasket layer's main function is to accommodate both irregularities in the sealing surface of the metal conduit and the adjacent shear gasket layer, as well as larger scale deviations from flatness in the sealing surface of the ceramic conduit.

The first shear gasket layer and the second shear gasket layer, if present, may comprise a mineral selected from the group consisting of mica, vermiculite, montmorillonite, graphite, and hexagonal boron nitride. The first shear gasket layer 71 and the second shear gasket layer 91, if present, may comprise at least 95 weight % of a mineral selected from the group consisting of mica, vermiculite, montmorillonite, graphite, and hexagonal boron nitride. The first shear gasket layer 71 and the second shear gasket layer 91, if present, may be mica paper, vermiculite paper, talc-infiltrated vermiculite paper, or boron nitride sheet. The first shear gasket layer 71 and the second shear gasket layer 91, if present, may be, for example, Flexitallic Thermiculite™ 866.

If mica paper is used, the mica paper may include a binder or the mica paper may be binderless. If vermiculite paper is used, the vermiculite paper may include a binder or the vermiculite paper may be binderless.

The term “mica” encompasses a group of complex aluminosilicate minerals having a layered structure with varying chemical compositions and physical properties. More particularly, mica is a complex hydrous silicate of aluminum, containing potassium, magnesium, iron, sodium, fluorine, and/or lithium, and also traces of several other elements. It is stable and completely inert to the action of water, acids (except hydro-fluoric and concentrated sulfuric) alkalies, conventional solvents, oils, and is virtually unaffected by atmospheric action. Stoichiometrically, common micas can be described as follows:

AB₂₋₃(Al, Si)Si₃O₁₀(F, OH)₂

where A=K, Ca, Na, or Ba and sometimes other elements, and where B═Al, Li, Fe, or Mg. Although there are a wide variety of micas, the following six forms make up most of the common types: Biotite, (K₂(Mg, Fe)₂(OH)₂(AlSi₃)₁₀)), Fuchsite (iron-rich Biotite), Lepidolite (LiKAl₂(OH, F)₂(Si₂O₅)₂), Muscovite (KAl₂(OH)₂(AlSi₃O₁₀)), Phlogopite (KMg₃Al(OH)Si₄O₁₀)) and Zinnwaldite (similar to Lepidolite, but iron-rich). Mica can be obtained commercially in either a paper form or in a single crystal form, each form of which is encompassed by various embodiments of the invention. Mica in paper form is typically composed of mica flakes and a binder, such as for example, an organic binder such as a silicone binder or an epoxy, and can be formed in various thicknesses, often from about 50 microns up to a few millimeters. Mica in single crystal form is obtained by direct cleavage from natural mica deposits, and typically is not mixed with polymers or binders.

The first surface of the first shear gasket layer may be at least essentially parallel to the second surface of the first shear gasket layer. The first shear gasket layer may have a thickness ranging from 0.025 mm to 0.75 mm, or ranging from 0.025 mm to 0.25 mm.

The first shear gasket layer, as part of the seal, prevents the flow of fluid through the junction, i.e. it “seals.”

If the second shear gasket layer is present, the first surface of the second shear gasket layer may be at least essentially parallel to the second surface of the second shear gasket layer. The second shear gasket layer, if present, may have a thickness ranging from 0.025 mm to 0.75 mm or ranging from 0.025 mm to 0.25 mm. The second shear gasket layer, as part of the seal, prevents the flow of fluid through the junction, i.e. it “seals.”

The first compliant gasket layer, the second compliant gasket layer, and the third compliant gasket layer, if present, each comprise a material selected from the group consisting of a glass, a glass-ceramic, a glass composite, a cermet, a metal, a metal alloy, and a metal composite. The first compliant gasket layer, the second compliant gasket layer, and the third compliant gasket layer, if present, may comprise the same material in the group or a different material from the group.

The first compliant gasket layer, the second compliant gasket layer, and the third compliant gasket layer, if present, may be a metal comprising at least 95 weight of gold, silver, palladium, or alloys thereof.

The first compliant gasket layer, the second compliant gasket layer, and the third compliant gasket layer, if present, may comprise at least 95 weight % of a glass, or a glass-ceramic which can advantageously be a machineable ceramic like Macor®.

In a preferred embodiment, for the multi-layer seal comprising 5 layers, the first compliant gasket layer, and the second compliant gasket layer, are a metal comprising at least 95 weight % of gold, silver, palladium, or alloys thereof, and the third compliant gasket layer comprises at least 95 weight % of a glass, or a glass-ceramic which can advantageously be a machineable ceramic like Macor®.

The first and second compliant gasket layers may have a thickness ranging from 0.0025 mm to 1.25 mm prior to heating or ranging from 0.025 mm to 1.25 mm prior to heating. The third compliant gasket layer may have a thickness ranging from 0.025 mm to 2.5 mm, or ranging from 0.025 mm to 1.25 mm prior to heating. If either the metal sealing surface or the ceramic sealing surface is not perfectly flat, the compliant layer should be sufficiently thick to accommodate any unevenness.

The thickness dimension of the shear gasket layer and the compliant gasket layer is the dimension normal to the sealing surfaces of the conduits.

The width dimension of the shear gasket layer and the compliant gasket layer corresponds to the thickness dimension of the conduit walls.

The width of the shear gasket layer(s) may be greater than, less than, or equal to the width of the compliant gasket layers. The width of the shear gasket layer(s) may be greater than, less than, or equal to the thickness of the ceramic conduit wall. The width of the shear gasket layer(s) may be greater than, less than, or equal to the thickness of the metal conduit wall. The thickness of the ceramic conduit wall may be greater than, less than, or equal to the thickness of the metal conduit wall. The width of the compliant gasket layers may be greater than, less than, or equal to the thickness of the ceramic conduit wall. The width of the compliant gasket layers may be greater than, less than, or equal to the thickness of the metal conduit wall.

For the multilayer seal comprising 5 layers, the third compliant gasket layer may be thicker than either of the first compliant gasket layer and the second compliant gasket layer.

To make the seal, a compliant gasket layer can be applied to the shear gasket layer in a variety of manners, including, for example and without limitation, dip-coating, painting, screen printing, deposition, spattering, tape casting, and sedimentation. In addition, the compliant gasket layer material can be provided in a variety of forms, including, for example, as fibers, granules, powders, slurries, liquid suspensions, pastes, ceramic tapes, metallic foils, metallic sheets, and others.

To seal a junction between a metal conduit and a ceramic conduit, a multi-layer seal as disclosed herein is positioned between the sealing surface of the metal conduit and the sealing surface of the ceramic conduit such that the first compliant gasket layer 61 is positioned against the sealing surface 65 of the ceramic conduit and the second compliant gasket layer is positioned between the first shear gasket layer 71 and the sealing surface 85 of the metal conduit. Sealing is then accomplished by applying a compressive force normal to the sealing surfaces, both to maintain the seal layers in their proper positions and to cause the compliant layers to mold to surface defects in adjacent surfaces under operating conditions of the device. The compressive force may be provided entirely by the pressure differential between the high- and low-pressure sides of the device (i.e. without mechanical means). Any suitable geometry may be used to create the compressive force by the pressure differential. The resulting compressive stress during operation or use may be from about 34.5 kPa (5 psi) to about 13.8 MPa (2000 psi), or from about 34.5 kPa (5 psi) to about 3446 kPa (500 psi), or from about 69 kPa (10 psi) to about 2757 kPa (400 psi), or from about 103.5 kPa (15 psi) to about 2068 kPa (300 psi).

The present seal may be conveniently used to connect a circular cross-section sealing surface of a ceramic conduit (like a flange) to a similar sealing surface of a metal conduit, while any suitable cross-sectional shape may be used. For this type of application, the shear gasket layer(s) and the compliant gasket layers may have a circular cross section (i.e. washer-shaped). For a given compressive force, decreasing the sealing area increases the compressive force per unit area acting on the seal. However, making the gasket narrower shortens the threshold distance for leakage through the seal. For this reason, there typically exists an optimum sealing area and it is generally not desirable that the shear gasket layer(s) and compliant gasket layers have the same internal and external diameter as one another, or as the conduits. Instead, the shear gasket layer(s) and compliant gasket layers should be sized to optimize the balance of compressive force per unit sealing area (which is the smaller of the shear gasket layer(s), the compliant gasket layer or one of the flange areas), the minimum seal dimension (distance between the high and low pressure gases), cost of seal components, and other considerations specific to the system being sealed.

The ion transport membrane assembly may include any of the features described in U.S. Pat. No. 7,179,323, U.S. Pat. No. 7,335,247, U.S. Pat. No. 7,425,231, U.S. Pat. No. 7,658,788, U.S. Pat. No. 7,771,519, and U.S. Pat. No. 8,114,193, incorporated herein by reference.

### EXAMPLES

Various seal configurations were tested by forming the seal between a superalloy seal cup and a 6.35 mm thick circular disk of MgO machined flat on the sealing face. The seal cup consists of a 38.1 mm diameter metal cup hollowed out so that the walls have an inner diameter of 25.4 mm. A metal tube is welded to the bottom of the cup and penetrates through to the hollowed out interior of the cup. This entire assembly is located within a pressure vessel which can be fed with air and controlled at pressures up to 1.76 MPa. The pressure vessel is located within a furnace, allowing testing within the target temperature range of 750-950° C.

The tube that is attached to the bottom of the cup at one end penetrates through the pressure boundary and leads to a mass flowmeter to allow measurement of the rate of air flow through the seal at any given time. Up to eight such seal stands/samples may be tested at one time in parallel within the pressure vessel. The seals are compressed solely by air pressure, with the downstream side of the seal at atmospheric pressure. The testing protocol generally consists of subjecting the samples to a series of cycles in which the temperature is raised to a predetermined level within the target range and the pressure is then raised to a point greater than or equal to 1.48 MPa. After a given duration at these conditions, the vessel is then depressurized to some minimum level (0.163 MPa in the case of these tests) and then cooled to a temperature below 50° C. before beginning the next cycle. For the tests provided as examples below, the duration of a cycle was typically 168 hours.

### Example 1

Mica gasket alone—a single phlogopite mica paper gasket, 35.56 mm OD by 27.94 mm ID by 0.1016 mm thick, was used. In this test, the cycles were conducted at 1.48 MPa. Two identical samples were tested.

### Example 2

Gold gasket alone—a single gold gasket, 35.56 mm OD by 27.94 mm ID by 0.0762 mm thick, was used. In this test, the cycles were conducted at 1.48 MPa. Four identical samples were tested.

### Example 3

Gold-mica-gold tri-layer seal—a set of three gaskets was used. The bottom and top gaskets were gold, 35.56 mm OD by 27.94 mm ID by 0.0762 mm thick. The middle gasket was phlogopite mica paper, 35.56 mm OD by 27.94 mm ID by 0.1016 mm thick. In this test, the cycles were conducted at 1.65 MPa. Two identical samples were tested.

### Example 4

Five-layer seal—a set of five stacked gaskets was used. The bottom and top gaskets were gold, 35.56 mm OD by 27.94 mm ID by 0.0254 mm thick. The second and fourth gaskets from the bottom were phlogopite mica paper, 35.56 mm OD by 27.94 mm ID by 0.1016 mm thick. The middle gasket was machined from Macor™ to 35.56 mm OD by 27.94 mm ID by 0.508 mm thick. Macor™ is a glass-ceramic material consisting of small crystallites of fluorophlogopite mica in a borosilicate glass matrix. In this test, the cycles were conducted at 1.65 MPa. Two identical samples were tested.

Results: The average leak rates (standard cc/min) measured for each example during each cycle are tabulated in Table 1.

TABLE 1
Leak Rate (sccm)

| | | | | | | | Gold-mica- | | | |
|---|---|---|---|---|---|---|---|---|---|---|
| Cycle | Mica alone | | Gold alone | | | | gold | | 5 layer | |
| 1 | 336 | 305 | 17.9 | 8.4 | 6.9 | 11.7 | 63 | 55 | 55 | 49 |
| 2 | 293 | 233 | failed | failed | failed | failed | 51 | 43 | 48 | 41 |
| 3 | 311 | 233 | | | | | 43 | 39 | 60 | 50 |
| 4 | 313 | 253 | | | | | 38 | 36 | 63 | 51 |
| 5 | | | | | | | 51 | 36 | 83 | 60 |

The mica seals provided fairly stable performance cycle-on-cycle, but the overall leak rate was high. The gold seals provided excellent performance, but only last one cycle. During the first cooldown period a dramatic increase in leak rate was observed, such that during the pressurization for the next cycle the leak rate became unmeasurably high.

The gold-mica-gold tri-layer seals provided quite good seal quality and maintained that performance over a series of five cycles. Experience has shown that these are excellent seals when forming a high-temperature seal between two seal surfaces that have been machined flat. However, when sealing to a surface that is not machined flat, a large amount of gold must be used to comply with the out-of-flatness of that surface. In those instances, the five-layered seal offers the advantage of providing additional compliance using a far less expensive material. In this example, Macor™ was used for this purpose. The overall seal performance was somewhat inferior to the gold-mica-gold seals, and there appears to be greater degradation cycle-on-cycle. However, this performance disadvantage may be acceptable in some applications and the cost advantage may make this a reasonable option.

We claim:

1. An ion transport membrane assembly comprising:
(a) a pressure vessel having an interior, an exterior, an inlet, a first outlet and a second outlet;
(b) a plurality of planar ion transport membrane modules operatively disposed in the interior of the pressure vessel, each planar ion transport membrane module comprising mixed metal oxide ceramic material and having an interior region and an exterior region, each membrane module terminating in a ceramic conduit having a sealing surface, wherein the inlet and the first outlet of the pressure vessel are in fluid flow communication with the exterior regions of the membrane modules;
(c) one or more gas manifolds in fluid flow communication with interior regions of the membrane modules and with the exterior of the pressure vessel,
wherein the ceramic conduit of each membrane module is connected to a metal conduit of the one or more gas manifolds with a multi-layer seal operatively disposed therebetween, each metal conduit having a sealing surface;
wherein each multi-layer seal comprises:
a first shear gasket layer;
a first compliant gasket layer wherein the first compliant gasket layer directly contacts the sealing surface of the ceramic conduit; and
a second compliant gasket layer wherein the second compliant gasket layer directly contacts the sealing surface of the metal conduit;
wherein the first shear gasket layer is operatively disposed between the first compliant gasket layer and the second compliant gasket layer.

2. The ion transport membrane assembly of claim 1 wherein the multi-layer seal further comprises:
a second shear gasket layer; and
third compliant gasket layer;
wherein the third compliant gasket layer is operatively disposed between the first shear gasket layer and the second shear gasket layer; and
wherein the second shear gasket layer is operatively disposed between the third compliant gasket layer and the second compliant gasket layer.

3. The ion transport membrane assembly of claim 2 wherein the first shear gasket layer and/or the second shear gasket comprises a mineral selected from the group consisting of mica, vermiculite, montmorillonite, graphite, and hexagonal boron nitride.

4. The ion transport membrane assembly of claim 2 wherein at least one of the first compliant gasket layer, the second compliant gasket layer and the third compliant gasket layer comprises a material selected from the group consisting of a glass, a glass-ceramic, a glass composite, a cermet, a metal, a metal alloy, and a metal composite.

5. The ion transport membrane assembly of claim 2 wherein the first shear gasket layer and/or the second shear gasket layer comprises at least 95 weight % of a mineral selected from the group consisting of mica, vermiculite, montmorillonite, graphite, and hexagonal boron nitride.

6. The ion transport membrane assembly of claim 2 wherein the first compliant gasket layer and the second compliant gasket layer is a metal comprising at least 95 weight % of gold, silver, palladium, or alloys thereof.

7. The ion transport membrane assembly of claim 2 wherein the material of the third compliant gasket layer is a glass, a glass-ceramic or a glass composite.

8. The ion transport membrane assembly of claim 2 wherein the first shear gasket layer has a thickness of 0.025 mm to 0.75 mm and the second shear gasket layer has a thickness of 0.025 mm to 0.75 mm.

9. The ion transport membrane assembly of claim 2 wherein the first compliant gasket layer has a thickness of 0.0025 mm and 1.25 mm prior to heating and the second compliant gasket layer has a thickness of 0.0025 mm and 1.25 mm prior to heating.

10. The ion transport membrane assembly of claim 2 wherein the third compliant gasket layer has a thickness of 0.025 mm and 2.5 mm prior to heating.

11. The ion transport membrane assembly of claim 2 wherein the thickness of the third compliant gasket layer is greater than the thickness of the first compliant gasket layer and greater than the thickness of the second compliant gasket layer.

12. The ion transport membrane assembly of claim 2 wherein at least one of the first shear layer and the second shear layer possesses the characteristic of lubricity or is a sheet-like structure comprising sheets or flakes which can be displaced relative to one another in directions which are essentially parallel to the sheets or flakes.

13. The ion transport membrane assembly of claim 1 wherein the ceramic conduit of each membrane module is constructed of one or more single phase multicomponent metal oxides and/or of one or more multiphase composite materials.

14. The ion transport membrane assembly of claim 1 wherein the ceramic conduit of each membrane module has a circular cross-section.

15. The ion transport membrane assembly of claim 1 wherein each of the metal conduits of the one or more gas manifolds has a circular cross-section.

16. The ion transport membrane assembly of claim 2 wherein each of the first compliant gasket layer, the second compliant gasket layer, the third compliant gasket layer, the first shear gasket layer, and the second shear gasket layer have a circular cross-section.
